(19) United States
(12) Patent Application Publication
(10) Pub. No.: US 2008/0008468 A1
(43) Pub. Date: Jan. 10, 2008

(54) Camera module

(75) Inventor: Wen-Qiang Ma, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/825,264

(22) Filed: Jul. 5, 2007

(30) Foreign Application Priority Data
Jul. 4, 2006 (CN) 200620074743.4

(51) Int. Cl. G03B 17/00

(52) U.S. Cl. 396/529

(57) ABSTRACT

A camera module (100) includes a camera unit (3) and a shielding housing for wrapping a main body (30) of the camera unit. The camera unit further includes the main body and a front end section (31), the front end section adapted for electrically connecting with a flexible substrate (5). The shielding housing includes a front end opening (140) for allowing the front end section of the camera unit to be exposed, and an outer extension section (110) located below the front end opening for supporting at least a part of the flexible substrate. With such an arrangement, the induced electromagnetic wave of the camera unit can be diminished through the use of the shielding housing, thereby stabilizing the transmission of electronic signal of the camera unit.

### BACKGROUND OF THE INVENTION

1. Field of the Invention

The present invention relates to a camera module for effectively reducing the electromagnetic interference (EMI) of a camera unit.

2. Description of the Related Art

Many electronic devices including mobile telephones are increasingly diversified in function, and many models with built-in cameras are now available in the market. These cameras often work under high frequency. Under such circumstance, it is desirable that a main body of the camera is enclosed by a shielding housing for reducing the electromagnetic wave generated by terminals of the camera modules when transmitting signals or shielding the terminals from external electromagnetic interference (EMI). Therefore, there is a need to provide a new camera module to resolve the above-mentioned shortcoming.

### SUMMARY OF THE INVENTION

A camera module according to an embodiment of the present invention includes a camera unit and a shielding housing for wrapping a main body of the camera unit. The camera unit further includes the main body and a front end section, the front end section adapted for electrically connecting with a flexible substrate. The shielding housing includes a front end opening for allowing the front end section of the camera unit to be exposed, and an outer extension section located below the front end opening for supporting at least a part of the flexible substrate. With such an arrangement, the induced electromagnetic wave of the camera unit can be diminished through the use of the shielding housing, thereby stabilizing the transmission of electronic signal of the camera unit.

Other features and advantages of the present invention will become more apparent to those skilled in the art upon examination of the following drawings and detailed description of preferred embodiments, in which:

### BRIEF DESCRIPTION OF THE DRAWINGS FIG. 1 is an exploded, perspective view of a camera module according to an embodiment of the present invention;

FIG. 2 is another perspective view of the camera module of FIG. 1, and;

FIG. 3 is an assembled, perspective view of the camera module of FIG. 1.

### DETAILED DESCRIPTION OF PREFERRED EMBODIMENT

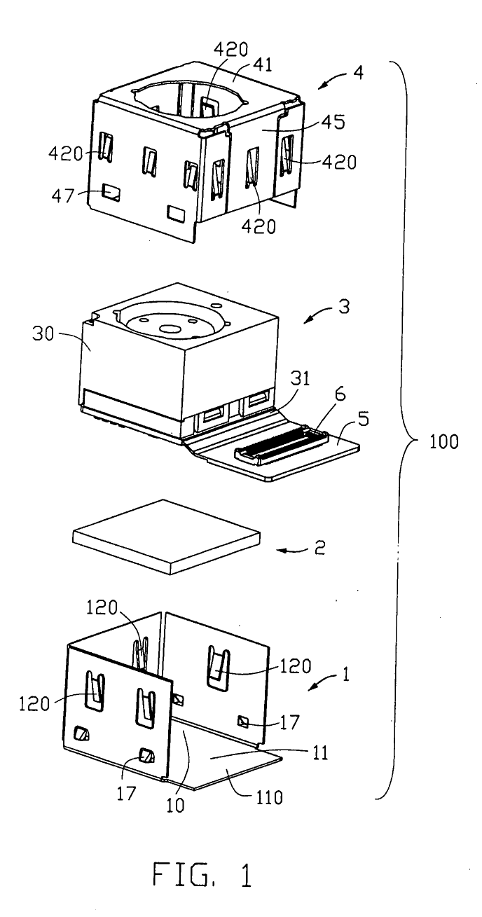

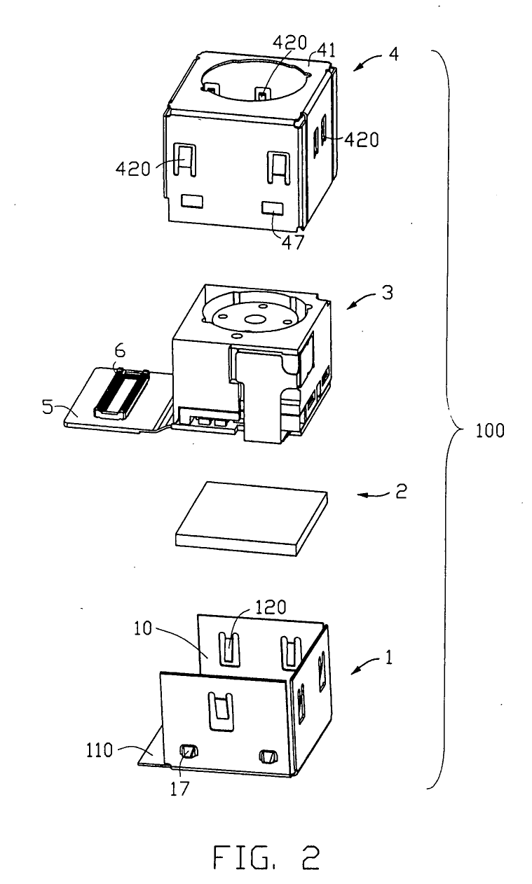

Referring to FIGS. 1 to 3, a camera module 100 according to an embodiment of the present invention includes a camera unit 3, a shielding housing for wrapping a main body 30 of the camera unit 3, a flexible substrate 5 connected with the camera unit 3 at a front end section 31 (see FIG. 1) of the camera unit 3, and an electrical connector 6 mountable onto a predefined region of the flexible substrate 5.

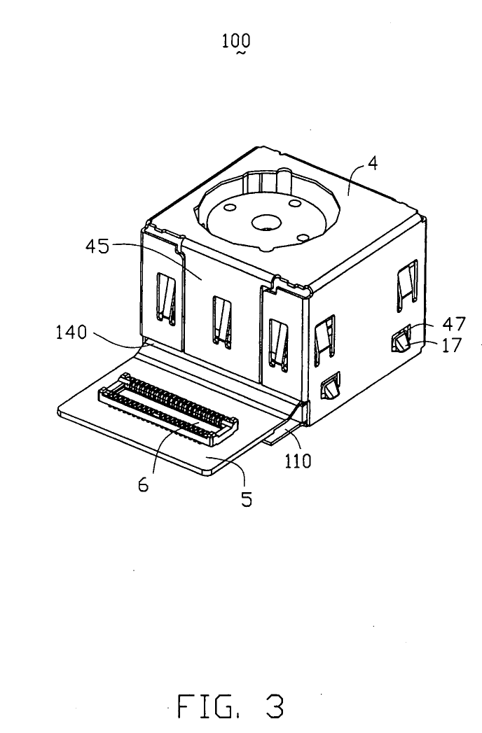

The camera unit 3 includes the main body 30, and the front end section 31 adapted for electrically connecting with the flexible substrate 5. The shielding housing is made from a metal material, and further includes an upper casing 4 and a lower casing 1 mated with each other. The upper casing 4 and the lower casing 1 together defines a front end opening 140 (see FIG. 3) aligned with the front end section 31 of the camera unit 3 for allowing the front end section 31 to be in such an exposed manner so as to facilitate the electrical interconnection with the flexible substrate 5. The shielding housing further includes an outer extension section 110 located below the front end opening 140 for supporting at least a part of the flexible substrate 5 connected with the camera unit 3 at the front end section 31.

More specifically, the lower casing 1 includes a bottom wall 11 with the outer extension section 110 attached thereto, and three side walls, thereby defining therebetween an insertion cavity 10 for the main body 30 of the camera unit 3 to be plugged therein. The three side walls further includes a plurality of first resilient contact tongues 120 integrally extending from the lower casing 1 downwardly and inwardly toward the camera unit 3, with each of the first resilient contact tongues 120 having a free end section thereof inwardly invading the insertion cavity 10 for resiliently tightly abutting against corresponding side walls of the main body 30 of the camera unit 3. The lower casing 1 further includes a plurality of outwardly extending tabs 17 aligned with holes 47 of the upper casing 4 (to be later described) for extending into the holes 47 of the upper casing 4 so as to form a reliable mechanical interconnection between the lower casing 1 and the upper casing 4.

The upper casing 4 includes a top wall 41 and four side walls, the four side walls adapted for resiliently engaging corresponding side walls of the lower casing 1 and a top wall of the main body 30 of the camera unit 3. More specifically, the upper casing 4 includes a plurality of second resilient contact tongues 420 integrally extending from the upper casing 4 upwardly and inwardly toward the lower casing 1 after assembled, with each of the second resilient contact tongues 420 having a free end section thereof inwardly and laterally invading a receiving space defined by the four side walls and the top wall 41 of the upper casing 4 so as to resiliently tightly abutting against the corresponding side walls of the lower casing 1 and the top wall of the main body 30 of the camera unit 3. The front side wall 45 of the upper casing 4 together with the outer extension section 110 of the lower casing 1 defines the front end opening 140 for allowing the front end section 31 of the camera unit 3 to be in the exposed manner in order to electrically connect with the flexible substrate 5.

Referring to FIGS. 1 and 3, in assembly, the main body 30 of the camera unit 3 with the flexible substrate 5 and the electrical connector 6 attached thereto is pre-plugged within the insertion cavity 10 defined by the lower casing 1, with a rubber insert 2 sandwiched between the outer extension section 110 and the flexible substrate 5. In such a state, the main body 30 of the camera unit 3 is fitted around the lower casing 1 by the first resilient contact tongues 120 resiliently tightly abutting against the corresponding side walls of the camera unit 3. The upper casing 4 is then applied to wrap and fit around the lower casing 1 and the camera unit 3 by the second resilient contact tongues 420 resiliently tightly abutting against the corresponding side walls of the camera unit 3 and the lower casing 1, and the tabs 17 of the lower casing 1 extending into the holes 47 of the upper casing 4. In such a state, the main body 30 of the camera unit 3 is wrapped/enclosed by the upper casing 4 and the lower casing 1. Therefore, the induced electromagnetic wave of the camera unit 3 can be diminished through the combination of the upper casing 4 and the lower casing 1. Thus, as compared with the prior art, the electromagnetic interference (EMI) can be effectively diminished to stabilize the transmission of electronic signal of the camera unit 3.

While the present invention has been described with reference to preferred embodiments, the description of the invention is illustrative and is not to be construed as limiting the invention. Various of modifications to the present invention can be made to preferred embodiments by those skilled in the art without departing from the true spirit and scope of the invention as defined by the appended claims.

What is claimed is:

1. A camera module comprising:
a camera unit, the camera unit having a main body and a front end section, the front end section adapted for connecting with a flexible substrate;
a shielding housing for wrapping said main body of the camera unit, the shielding housing having a front end opening for allowing said front end section to be exposed, and an outer extension section located below the front end opening for supporting at least a part of said flexible substrate.

2. The camera module of claim 1, wherein the shielding housing includes a plurality of resilient contact tongues extending from the shielding housing toward the camera unit for resiliently engaging the camera unit.

3. The camera module of claim 1, wherein the shielding housing includes a first casing and a second casing mated with each other.

4. The camera module of claim 3, wherein the first casing includes a plurality of first resilient contact tongues extending from the first casing toward the camera unit for resiliently engaging sidewalls of the camera unit.

5. The camera module of claim 4, wherein the second casing includes a plurality of second resilient contact tongues extending from the second casing toward the first casing for resiliently mating with sidewalls of the first casing.

6. The camera module of claim 4, wherein the first casing further includes a plurality of outwardly extending tabs and the second casing includes a plurality of holes for receiving the tabs.

7. The camera module of claim 3, wherein the first casing includes a bottom wall and three side walls, the bottom wall including said outer extension section, said three side walls adapted for resiliently abutting against corresponding side walls of the camera unit.

8. The camera module of claim 7, wherein the second casing includes a top wall and four side walls, said four side walls adapted for resiliently abutting against corresponding side walls of the first casing and the camera unit, one of said four side walls cooperating with said outer extension section to define said front end opening.

9. A camera module assembly:
a metallic shell defining an inner receiving cavity with a front opening communicating the receiving cavity with an exterior in a first direction;
a rubber piece seated upon a bottom plate of the shell; and
a camera unit received in the receiving cavity and cooperating with the bottom plate to sandwich the rubber therebetween; wherein
said camera further includes a flexible substrate extends from the front opening to the exterior, and a connector is mounted on the flexible substrate.

10. The camera modular assembly as claimed in claim 9, wherein said shell further includes an upper opening communicating said receiving cavity with the exterior in a second direction perpendicular to the first direction.

11. The camera module assembly as claimed in claim 9, wherein said shell includes an upper shell unit and a lower shell unit cooperatively defining said front opening.

12. The camera module assembly as claimed in claim 9, wherein said bottom plate extends beyond the front opening so as to provide additional support to the flexible substrate.
